(19) United States
(12) Patent Application Publication
(10) Pub. No.: US 2005/0134042 A1
(43) Pub. Date: Jun. 23, 2005

(54) Corrugated pipe with joint portion

(76) Inventors: Yasuhiro Kikumori, Osaka-shi (JP); Akihiro Fujii, Osaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/990,526

(22) Filed: Nov. 18, 2004

(30) Foreign Application Priority Data
Nov. 20, 2003 (JP) 2003-390185

(51) Int. Cl. F16L 39/00

(52) U.S. Cl. 285/319; 285/903

(57) ABSTRACT

A corrugated pipe having a joint portion, in which the insertion of the pipe wall end portion of a connecting partner corrugated pipe into a joint portion is allowed by pushing and expanding the retaining members of the joint portion with the ridge of the pipe wall end portion, and in which the pipe wall end portion is prevented from being drawn out from the joint portion, by fitting the retaining members in the clearances between the adjoining ridges of the pipe wall end portion.

### BACKGROUND OF THE INVENTION

1. Field of the Invention

This invention relates to a structure of a corrugated pipe provided with a joint portion for connecting the corrugated pipe.

2. Description of the Related Art

In the prior art, a corrugated pipe, which is made of a synthetic resin and which has a wall formed into corrugations composed of ridges and valleys so that it is excellent in pressure- and flattening-resistance, is widely employed as a protective pipe for accommodating and protecting cables such as electric cables or optical fiber cables, or as a water supply pipe or a sewer pipe.

Of these, especially the corrugated pipe having ridges formed into a generally square shape of cross section in the pipe radial direction can be used to realize a stable pipe installation with little torsion, as disclosed in JP-A-8-219333(Japanese Patent Laid-open Number 1996-219333), for example. In case a multi-hole conduit is to be formed by bundling a plurality of pipes in parallel, moreover, the parallelity and straightity of pipes can be kept excellent.

At the piping time of this kind, as disclosed in JP-A-8-219333, the plural corrugated pipes are sequentially added by using a corrugated pipe having a joint portion on its one end side and by inserting the other end side of a corrugated pipe on a connecting partner side to be connected, into the joint portion of the corrugated pipe.

In the connection structure using the corrugated pipe with the joint portion, as disclosed in JP-A-8-219333, however, only an O-ring is interposed between the joint portion of the corrugated pipe and the connecting partner corrugated pipe to be inserted. If a strong pulling force acts on those corrugated pipes, therefore, the connecting partner corrugated pipe may come out from the joint portion.

It is also conceivable to provide the joint portion with an engagement member so that the connecting partner corrugated pipe may be prevented from being drawn out from the joint portion by bringing the engagement member into engagement with the ridge of the connecting partner corrugated pipe. However, the mere provision of the joint portion with the engagement member enlarges the outside shape of the joint portion. As a result, the joint portion expands more than the ridge of the corrugated pipe or bulges on its outer periphery, and this expansion or bulge may obstruct the bundling of the corrugated pipes thereby to trouble the formation of the aforementioned multi-hole conduit.

### SUMMARY OF THE INVENTION

This invention has an object to provide a corrugated pipe with a joint portion, which can prevent a corrugated pipe on the connecting partner side reliably from being drawn out. Another object is to provide a corrugated pipe with a joint portion, which can minimize the expansion at the joint portion of the corrugated pipe from the ridge so as to raise no trouble at the time of forming a multi-hole conduit.

In order to achieve the above-specified objects, according to this invention, there is provided a corrugated pipe having a joint portion and made of a synthetic resin, which has ridges and valleys alternately in the pipe axis direction and in which the ridges are formed into a generally square section in the pipe radial direction. The corrugated pipe is provided, on one end side of its pipe wall, integrally with a joint portion having a generally square section, into which the end portion of the pipe wall of such a corrugated pipe on the connecting partner side having a pipe wall similar to the pipe wall is inserted. The joint portion equips on its inner wall face with retaining members which are gradually lifted inwardly as they go farther from the mouth of the joint portion and which are made of a thin, rigid material having inward and outward elasticities. The insertion of the pipe wall end portion of the connecting partner corrugated pipe into the joint portion is allowed by pushing and expanding the retaining members against the elastic forces thereof with the ridge of the pipe wall end portion. The pipe wall end portions in the connecting partner corrugated pipe is prevented from being drawn out from the joint portion, by fitting the retaining members in the clearances between the adjoining ridges of the pipe wall end portions in the connecting partner corrugated pipe inserted into the joint portion by their own elastic returning forces thereby to bring the leading ends of the retaining members into abutment of that one of the adjoining ridges which is located on the remoter side from the mouth.

According to the corrugated pipe with the joint portion of this invention, merely by inserting the pipe wall end portion of the connecting partner corrugated pipe into the joint portion, the retaining members equipped on the inner wall faces of the joint portion can be brought into engagement with the ridge of the connecting partner corrugated pipe thereby to connect the connecting partner corrugated pipe and the joint portion simply to each other while the connecting partner corrugated pipe being prevented from being drawn out.

By using the retaining members made of a thin, rigid member such as a metal sheet, moreover, the strength of the retaining members can be enhanced to prevent the corrugated pipe reliably from being drawn out. By narrowing the space for equipping the retaining members inward and outward in the joint portion, on the other hand, the outward expansion of the joint portion can be minimized. This can raise no trouble when the plural corrugated pipes are bundled in parallel to form the multi-hole conduit.

### BRIEF DESCRIPTION OF THE DRAWINGS

FIG. 1 is an exploded perspective view showing a corrugated pipe with a joint portion according to one embodiment of the invention;

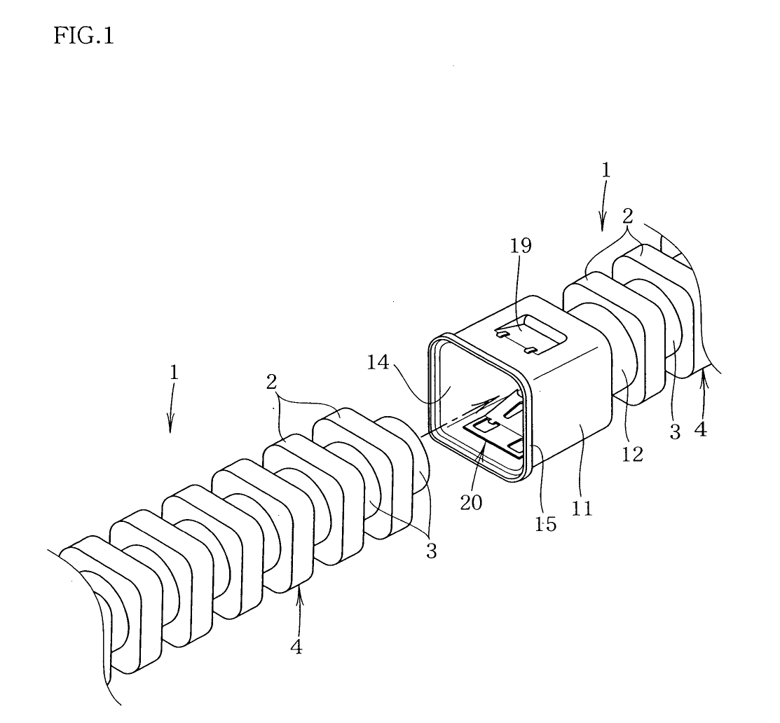

FIG. 2 is a longitudinal section of the corrugated pipe;

FIG. 3 is a longitudinal section of the vicinity of a bayonet of the corrugated pipe;

FIG. 4 is a partially broken perspective view of the joint portion;

FIG. 5 is an exploded perspective view of the joint portion;

FIG. 6 is a longitudinal section showing the state, in which a corrugated pipe on a connecting partner side is being inserted;

FIG. 7 is a longitudinal section showing the state, in which the insertion of the connecting partner corrugated pipe is completed;

FIG. 8 is a longitudinal section of the connecting partner corrugated pipe having a packing mounted thereon; and

FIG. 9 is a longitudinal section showing the state, in which the insertion of the connecting partner corrugated pipe is also completed.

### DETAILED DESCRIPTION OF THE INVENTION

Embodiments of the invention will be described in detail with reference to the accompanying drawings. In these drawings, reference numeral (1) designates a corrugated pipe with joint portion made of a synthetic resin by a blow molding method, for example. This corrugated pipe (1) is provided with a pipe wall (4) having annular ridges (2) and valleys (3) alternately in the pipe axial direction. Of these, the ridges (2) are formed to have a generally square section, and the valleys (3) are formed to have a generally circular section. Moreover, the pipe wall (4) can accommodate cables such as electric wire cables or optical fiber cables.

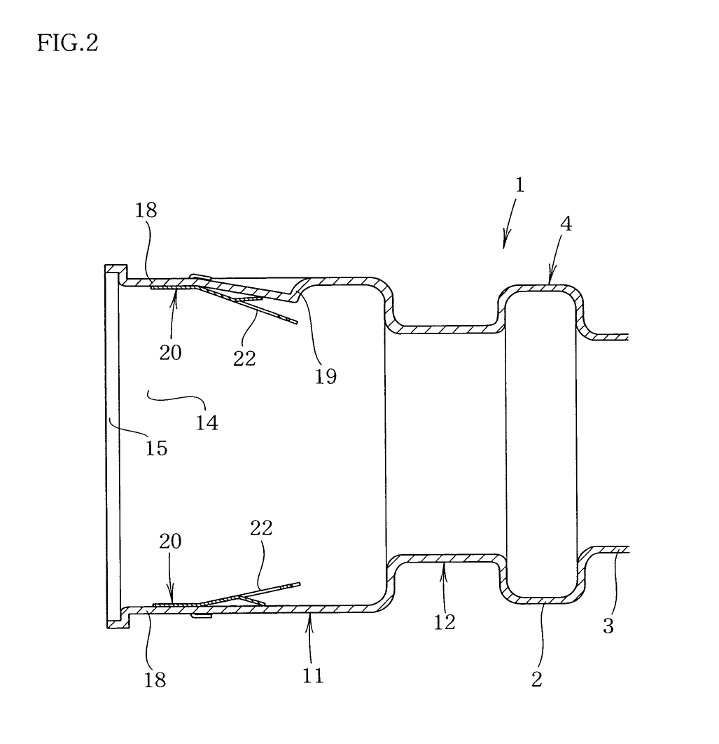

With one end side of the pipe wall (4) of the corrugated pipe (1), moreover, there is integrally formed through a connector (12) a joint portion (11), into which the other end portion of the wall of the corrugated pipe (1) on the connecting partner side is inserted, as shown in FIG. 2.

The joint portion (11) is formed to have a generally square shape, one side of which has a slightly larger length than that of one side of the outer periphery of the ridges (2) of the pipe wall (4). Around the mouth (14) of the joint portion (11), there is formed in an expanded state a flange (15) for holding the shape of the mouth (14) and facilitating the insertion of the other end portion of the pipe wall of the connecting partner corrugated pipe (1).

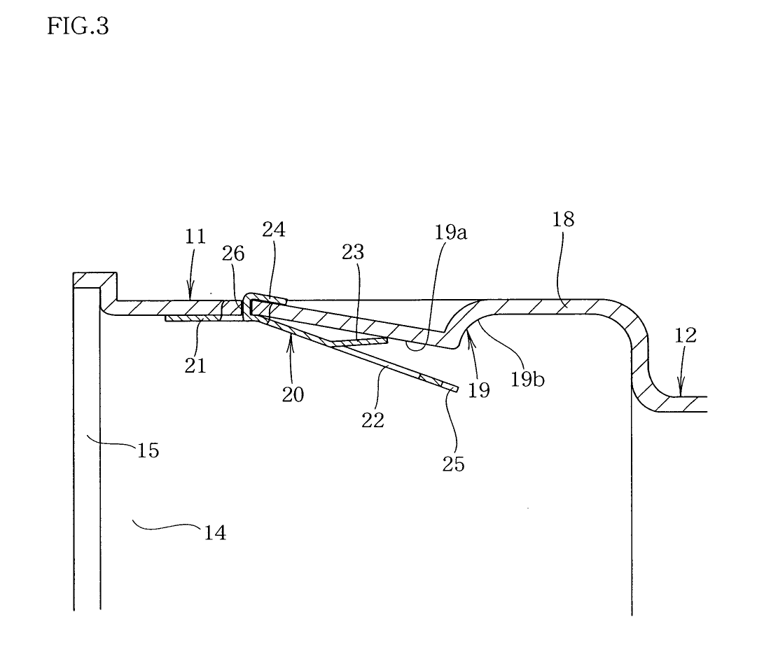

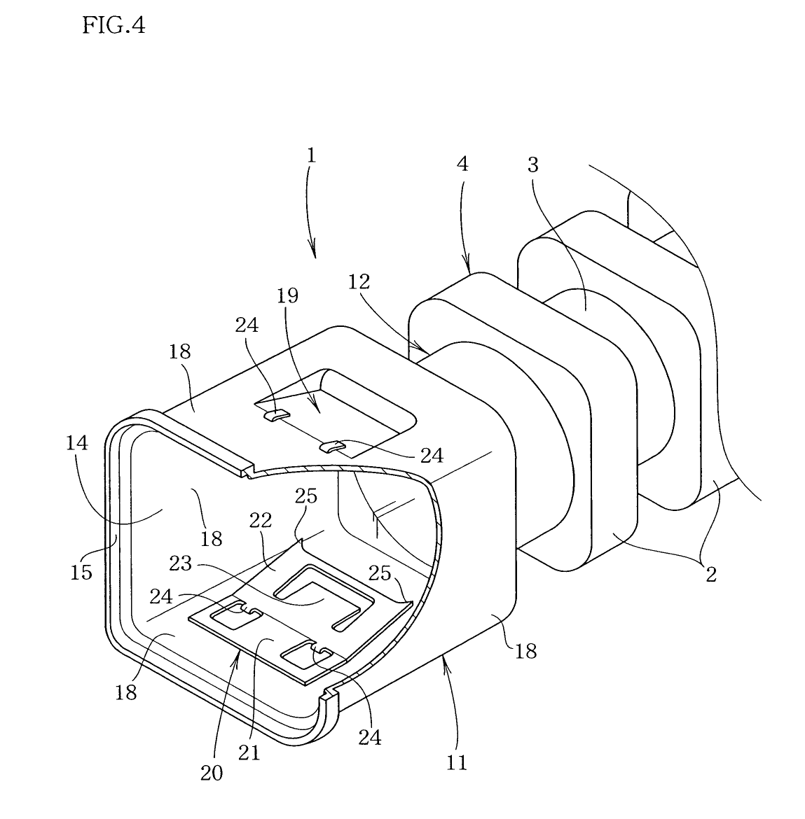

This joint portion (11) is provided with a protrusion (19) on its inner wall face by pressing in the central portion of one of four side walls (18), (18), . . . , and so on, as shown in FIG. 3 and FIG. 4. This protrusion (19) is provided with: a sloped face 19a having a protrusion gradually increasing the more inward (toward the center axis of the joint portion) as it goes the farther from the mouth (14); and a curved face (19b) shaped to accept the rounded corners of the ridges (2). This curved face (19b) is located closer to the connector (12) than the sloped face (19a). Here, the protrusion (19) should not be limited to one side wall (18) but may be disposed on the opposed side walls (18) and (18), on the orthogonal side walls (18) and (18), or on the three or four sidewalls (18), (18), . . . , and so on.

The joint portion (11) is further equipped on the inner wall face with a pair of bayonets (20) and (20) facing each other for preventing the connecting partner corrugated pipe (1) inserted into the joint portion (11) from being drawn out.

This bayonet (20) is formed by punching or bending a metal sheet as a thin, rigid member, as shown in FIG. 3 and FIG. 4. Moreover, the bayonet (20) is composed of: a base member (21) extending along the inner wall face of the joint portion (11); a retaining member (22) extending from the end portion of the base member (21) on the side of the connector (12); a energizing member (23) extending from the intermediate portion of the retaining member (22); and a pair of stopper members (24) and (24) extending from the end portion of the retaining member (22) on the side of the mouth (14).

The retaining member (22) is formed into such a generally rectangular shape as has a gradually lifted inwardly face as it goes away from the mouth (14), and has inward and outward elasticities (i.e., toward and away from the joint portion center axis) so that it functions as a plate spring. Moreover, the retaining member (22) is provided with a pair of acute bite pawls (25) and (25) at the end portion thereof on the side of the connector (12), i.e., at its leading end portion. Here, these bite pawls (25) and (25) are formed individually at the two ends of the leading end portion but may also be formed either only one at the center of the leading end portion or in a saw tooth shape all over the leading end portion.

The energizing member (23) is formed into a generally rectangular shape, for example, and is arranged at the central opening portion of the retaining member (22). This energizing member (23) has a gradually increasing extension in the outward direction (i.e., away from the joint portion center axis) as its goes away from the mouth (14), to come into abutment at its leading end portion against the inner wall face of the joint portion (11). At the same time, the energizing member (23) has inward and outward elasticities to function as a plate spring. In short, the energizing member (23) holds the retaining member (22) in the inward extending state in the joint portion (11). Moreover, the energizing member (23) is caused, by the repulsive force resulting from the push of the inner wall face of the joint portion (11) when the retaining member (22) is pushed outward, to bias energize the retaining member (22) inward thereby to assist the elastic return of the retaining member (22).

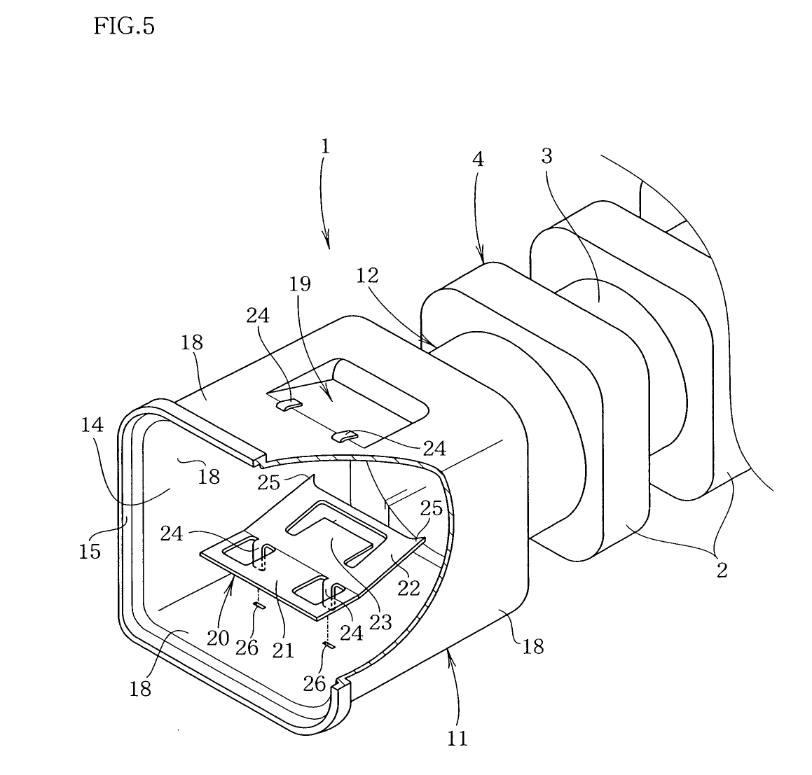

As shown in FIG. 3 and FIG. 5, the stopper members (24) are formed into a slender band shape. The stopper members (24) are extended through through holes (26) formed in the side wall (18) of the joint portion (11), and are folded back along the outer wall face of the joint portion (11). By these stopper members (24), the bayonet (20) is mounted on the inner wall face of the joint portion (11). As a result, it is possible to simplify the mounting structure of the bayonet (20) and the mounting work.

Thus, the bayonet (20) is made of a thin metal sheet and is wholly mounted generally along the side wall (18) of the joint portion (11). Therefore, the joint portion (11) equipped with those bayonets (20) and (20) can narrow the space for the bayonets (20) and (20) inward and outward thereby to minimize its outer periphery.

Here, one of the paired bayonets (20) and (20) is disposed to mount its retaining member (22) on the sloped face (19a) of the protrusion (19), but their mounted positions should not be limited to that. For example, both the bayonets (20) and (20) may also be mounted on the side walls (18) and (18) having no protrusion (19). Moreover, the number of the bayonets (20) and (20) may also be one or three or more.

The connector (12) is formed into a generally circular section having a smaller outer circumference than that the outer periphery of the joint portion (11). Moreover, the internal diameter of the connector (12) is made so slightly larger than the external diameter of the valley (3) of the corrugated pipe (1) that the valley (3) of the other end portion of the pipe wall in the connecting partner corrugated pipe (1) can be inserted into the connector (12).

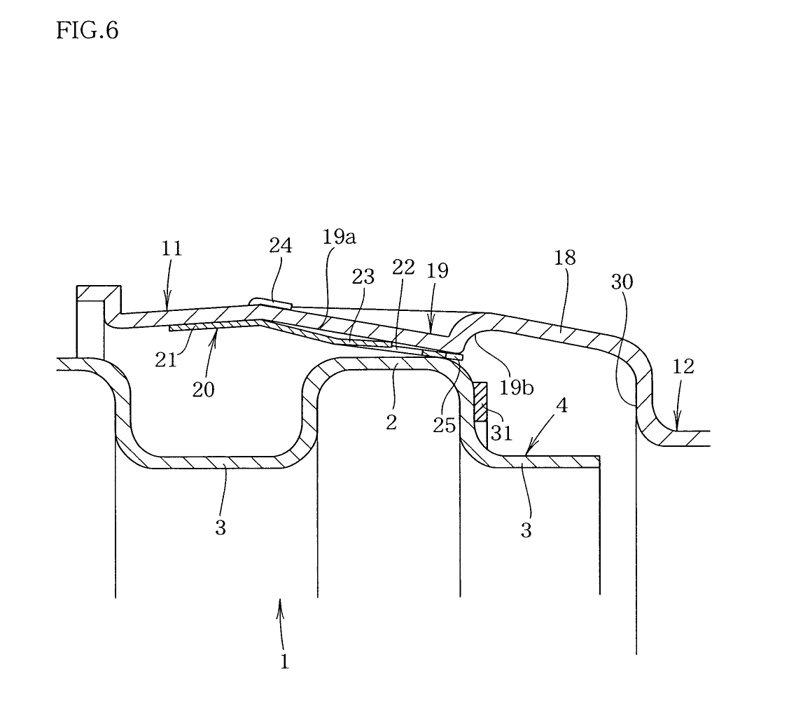

Here will be described the connection of the end portions of the corrugated pipes (1) and (1) having the aforementioned joint portions. First of all, the other end portion of the pipe wall of the connecting partner corrugated pipe (1) is inserted into the mouth (14) of the joint portion (11) of one corrugated pipe (1). At this time, the ridge (2) of the connecting partner corrugated pipe (1) move while abutting against the retaining members (22) and (22) of the bayonets (20) and (20), as shown in FIG. 6. As a result, the retaining members (22) and (22) are pushed back outward against their elastic forces and the energizing forces of the energizing members (23) and (23) thereby to allow the other end portion of the pipe wall of the connecting partner corrugated pipe (1) to be inserted into the joint portion (11). Simultaneously with this, the ridge (2) of the connecting partner corrugated pipe (1) pushes the protrusions (19) of the joint portion (11) gradually outward so that the inner wall face of the joint portion (11) is expanded outward.

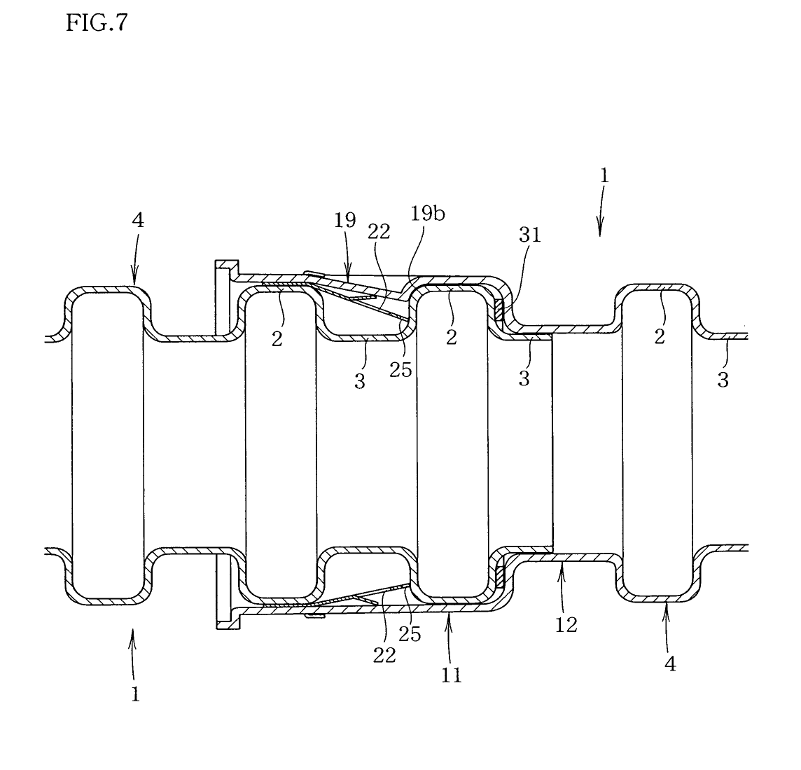

As shown in FIG. 7, moreover, the ridge (2) of the connecting partner corrugated pipe (1) passes over the retaining members (22) and (22) and the protrusions (19) and comes into abutment against the stepped face (30) between the joint portion (11) and the connector (12). When the leading end valley (3) of the connecting partner corrugated pipe (1) is fitted in the connector (12), the insertion of the connecting partner corrugated pipe (1) is completed.

At this time, the retaining members (22) and (22) are elastically returned by their own elastic forces and the energizing forces of the energizing members (23) and (23). Meanwhile, the base members (21) are pushed onto the inner wall face of the joint portion (11) by the ridge (2) in the other end portion of the pipe wall of the connecting partner corrugated pipe (1). As a result, the retaining members (22) and (22) hold the inwardly lifted state without any rattling. Then, those retaining members (22) and (22) are fitted in the clearances between the adjoining ridges (2) and (2) of the other end portion of the pipe wall of the connecting partner corrugated pipe (1), and the bite pawls (25), (25), . . . , and so on at the leading end portions of the retaining members (22) and (22) bite into the remoter one (2) of the adjoining ridges (2) and (2) from the mouth (14). Specifically, the bite pawls bite into side faces of the ridge (2) extending in the pipe radial direction. As a result, the connecting partner corrugated pipe (1) is reliably prevented from being drawn out from the joint portion (11). Here in the corrugated pipe (1) formed by the blow molding method, the radial side faces in the ridge (2) of the pipe wall (4) may be slightly inclined with respect to the pipe radial direction. In this case, the retaining members (22) and (22) easily slip if their leading ends are just brought into abutment against the inclined side faces of the ridge (2). However, the acute bite pawls (25), (25), . . . , and so on are formed at the leading end portions of the retaining members (22) and (22) to bite into the side faces of the ridge (2). These bites can prevent the corrugated pipe (1) reliably from being drawn out, even if the side faces of the ridge (2) are inclined.

Simultaneously with these bites of the bite pawls (25), (25), . . . , and so on, moreover, the inner wall faces of the joint portion (11) elastically return, and the protrusions (19) go into the clearances between the adjoining ridges (2) and (2) of the other end portion of the pipe wall of the connecting partner corrugated pipe (1) such that their curved faces (19b) slide along the corners of the ridge (2) on the remoter side from the mouth (14). As a result, the connecting partner corrugated pipe (1) can be firmly fixed in the joint portion (11). When the protrusions (19) fit into the clearances between the adjoining ridges (2) and (2), moreover, the inner wall faces of the joint portion (11) click against the outer wall faces of the connecting partner corrugated pipe (1). This is a sign that the connecting partner corrugated pipe (1) has been snugly inserted to the depth thereby to complete the insertion, so that the insertion failure can be prevented. A ring-shaped packing (31) is mounted between the connecting partner corrugated pipe (1) and the stepped face (30) on the side of the joint portion (11).

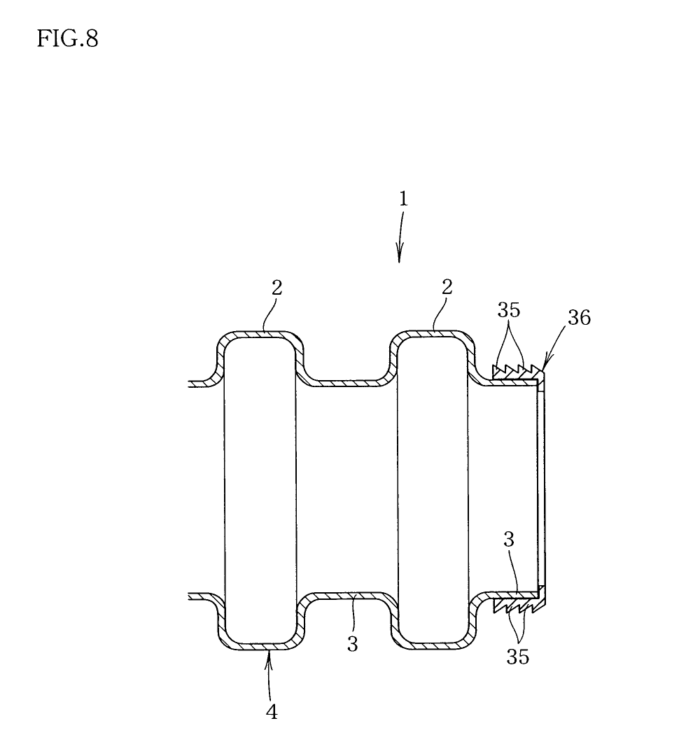

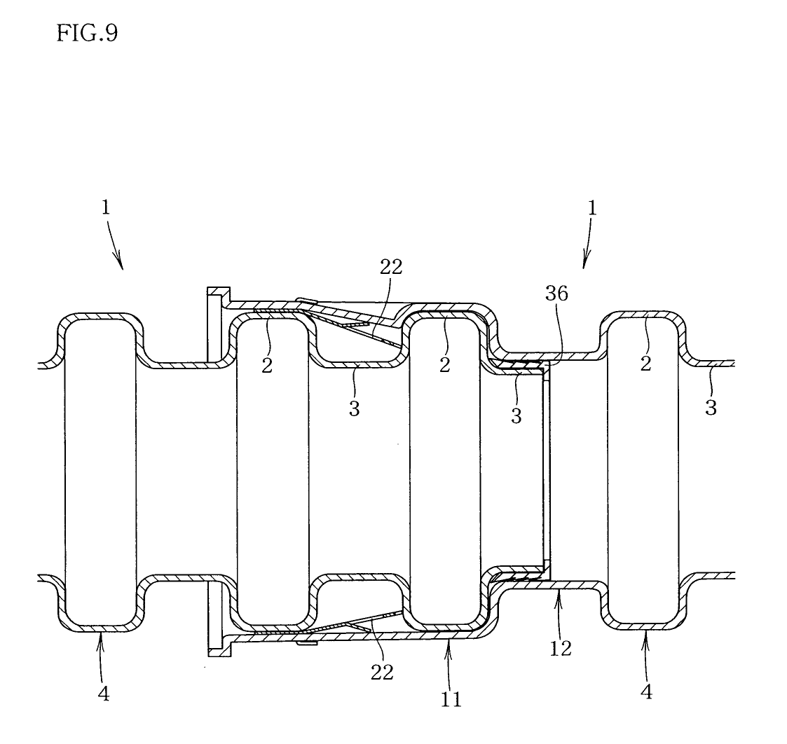

That ring-shaped packing (31) is replaced by short-cylinder packing (36), which has a plurality of annular fins (35), (35), . . . , and so on on its outer circumference and is mounted around the leading end valley (3) of the connecting partner corrugated pipe (1), as shown in FIG. 8 and FIG. 9. Moreover, the valley (3) having the packing (36) mounted thereon is fitted in the connector (12), and the annular fins (35), (35), . . . , and so on of the packing (36) may be pushed onto the inner wall face of the connector (12), thereby to stop the water.

When the insertion of the connecting partner corrugated pipe (1) is thus completed by the single action, the other end portion of the pipe wall of another corrugated pipe (1) is likewise inserted by the single action. By repeating these actions sequentially, the corrugated pipes (1) are added for the piping operation. In this case, even if the pipe wall (4) of any corrugated pipe (1) is cut for length adjustment at an arbitrary portion, the corrugated pipe (1) can be connected by inserting its cut end portion into the joint portion (11) of the connecting partner corrugated pipe (1).

This invention should not be limited to the embodiments thus far described but can naturally add many corrections and modifications to the embodiments within the scope of the invention. For example, the connecting partner corrugated pipe should not be limited to the aforementioned one having the joint portion but may be a corrugated pipe having no joint portion on its one end side, if it is provided with at least a pipe wall like that of the corrugated pipe having the joint portion. Moreover, the pipe wall of the corrugated pipe should not be limited to the structure, in which the ridges have the generally square section in the pipe radial direction whereas the valleys have the circular section, but may also have a structure, in which both the ridges and the valleys are formed to have a generally square section. In addition, the corrugations of the pipe wall should not be limited to the annular shape but may also be made helical.

1. A corrugated pipe having a joint portion and made of a synthetic resin, which has ridges and valleys alternately in the pipe axis direction and in which said ridges are formed into a generally square section in the pipe radial direction,
wherein said corrugated pipe is provided, on one end side of its pipe wall, integrally with a joint portion having a generally square section, into which the end portion of the pipe wall of such a corrugated pipe on the connecting partner side having a pipe wall similar to said pipe wall is inserted,
wherein said joint portion equips on its inner wall face with retaining members which are gradually lifted inwardly as they go farther from the mouth of said joint portion and which are made of a thin, rigid material having inward and outward elasticities, whereby the insertion of the pipe wall end portion of said connecting partner corrugated pipe into said joint portion is allowed by pushing and expanding said retaining members against the elastic forces thereof with the ridge of said pipe wall end portion, and whereby said pipe wall end portions in the connecting partner corrugated pipe is prevented from being drawn out from said joint portion, by fitting said retaining members in the clearances between the adjoining ridges of the pipe wall end portions in said connecting partner corrugated pipe inserted into said joint portion by their own elastic returning forces thereby to bring the leading ends of said retaining members into abutment of that one of said adjoining ridges which is located on the remoter side from said mouth.

2. A corrugated pipe having a joint portion according to claim 1,
wherein said ridges and said valleys are formed into an annular shape.

3. A corrugated pipe having a joint portion according to claim 1,
wherein said retaining members are made of a metal sheet.

4. A corrugated pipe having a joint portion according to claim 1,
wherein energizing members extending from said retaining members are brought into abutment against the inner wall faces of said joint portion thereby to bias energize said retaining members expanded outward, in the inward direction.

5. A corrugated pipe having a joint portion according to claim 1,
wherein said retaining members are extended from base members disposed along the inner wall faces of said joint portion so that the inwardly lifted state of said retaining members is held by pushing said base members onto the inner wall faces of said joint portion with that ridge of the pipe wall end portion in said connecting partner corrugated pipe which is inserted into said joint portion.

6. A corrugated pipe having a joint portion according to claim 1,
wherein acute bite pawls to bite into said ridge of the pipe wall end portion in said connecting partner corrugated pipe are formed at the leading end portions of said retaining members.

7. A corrugated pipe having a joint portion according to claim 1,
wherein stopper members extending from said retaining members are folded back through said joint portion along the outer wall faces of said joint portion thereby to mount said retaining members on the inner wall faces of said joint portion.

8. A corrugated pipe having a joint portion according to claim 1,
wherein said joint portion is provided on its inner wall faces with protrusions which are gradually expanded outward by the ridge of the pipe wall end portion in said connecting partner corrugated pipe being inserted, thereby to fit in the clearances between the adjoining ridges of the pipe wall end portion in said connecting partner corrugated pipe end portions having completed the insertion.

9. A corrugated pipe having a joint portion according to claim 1,
wherein said joint portion equips on its inner wall faces with a pair of retaining members opposed to each other.

10. A corrugated pipe having a joint portion according to claim 1,
wherein said joint portion is connected to one end side of said pipe wall through a connector, and wherein said connector is made smaller than the outer periphery of said joint portion and formed into a generally circular section for allowing of the valley of the pipe wall end portion in said connecting partner corrugated pipe to be inserted thereinto.
